(19) United States
(12) Patent Application Publication
(10) Pub. No.: US 2025/0364607 A1
(43) Pub. Date: Nov. 27, 2025

(54) ELECTROLYTE SOLUTION AND NICKEL-ZINC BATTERY USING THIS ELECTROLYTE SOLUTION

(71) Applicant: GP Technology & Innovation Limited, Hong Kong (CN)

(72) Inventors: Bin WANG, Hong Kong (CN); Yuzhan Zhang, Hong Kong (CN); Yechen Lei, Hong Kong (CN); Xiujuan Jiang, Hong Kong (CN)

(21) Appl. No.: 19/215,739

(22) Filed: May 22, 2025

(30) Foreign Application Priority Data
May 24, 2024 (CN) 202410656375.7

(51) Int. Cl. H01M 10/26; H01M 10/30

(52) U.S. Cl. CPC H01M 10/26; H01M 10/30; H01M 2300/0014

(57) ABSTRACT

The present invention relates to an electrolyte solution adopting deionized water as a main solvent, comprising the following components: an electrolyte containing hydroxide radical, a pyrophosphate and a tripolyphosphate. With regard to content of hydroxide radical in the electrolyte solution, corresponding content of hydroxide radical is 7 to 18 mol per 1 L of deionized water; a ratio of total weight of deionized water and the electrolyte to weight of the pyrophosphate is 1:0.01 to 0.1; and a ratio of total weight of deionized water and the electrolyte to weight of the tripolyphosphate is 1:0.01 to 0.1. The present invention also relates to a nickel-zinc battery comprising the above-described electrolyte solution, and this electrolyte solution may heighten cyclic stability of nickel-zinc battery, heighten utilization rate of the negative electrode active material, promote discharge capacity and energy density of the battery, have advantages such as inhibiting dendrite growth, reducing gas evolution side reaction within the battery and heightening coulombic efficiency during charge and discharge.

### TECHNICAL FIELD

The present invention relates to the technical field of nickel-zinc battery, particularly relates to an electrolyte solution and nickel-zinc battery using this electrolyte solution.

### BACKGROUND

This part provides background information relating to the present application, which does not necessarily constitutes the prior art.

As a secondary alkaline battery, nickel-zinc battery has a specific energy density in terms of weight far higher than the existing rechargeable aqueous battery system, such as lead-acid battery and nickel-metal hydride alkaline battery. Specific energy density in terms of weight of nickel-zinc battery cell may even be up to 120 Wh/Kg or more, relatively close to that of lithium iron phosphate battery with organic system. Additionally, nickel-zinc battery also has good rate performance, wide-temperature performance and safety performance. Particularly, nickel-zinc battery may even have discharge rate up to 20 C and be capable of being subjected to normal charge and discharge in an environment of −30° C. to 60° C. Since nickel-zinc battery uses an alkaline electrolyte solution with deionized water as a main solvent, it has the privilege of intrinsic safety, and there is not a problem of potential safety hazard such as thermal runaway and explosion of battery. Therefore, nickel-zinc battery has wide application prospects in fields such as traction battery, household energy storage, industrial uninterruptible power supply (UPS) and large-scale energy storage.

Nickel hydroxide (Ni(OH)₂) or cobalt-coated nickel hydroxide is generally adopted as a positive material of nickel-zinc battery, and a zinc-based negative electrode composed of active substance such as zinc oxide and zinc powder is usually adopted as a negative material of nickel-zinc battery. With nickel-zinc battery, the process of charge and discharge thereof is finished through back-and-forth migration of hydroxide ion (OH) in the electrolyte solution between positive electrode and negative electrode, forming internal closed loop. More particularly, during charge of nickel-zinc battery, Ni(OH)₂ is oxidized into NiOOH at the positive electrode, and ZnO is reduced into metal Zn at the negative electrode. During discharge of nickel-zinc battery, NiOOH is reduced into Ni(OH)₂, metal Zn is oxidized into ZnO at the negative electrode. The whole process of charge and discharge cycle is electrochemically reversible.

Currently, the positive material of nickel-zinc battery, Ni(OH)₂ has successfully applied in a plurality of aqueous alkaline battery systems, such as nickel-metal hydride battery, nickel-cadmium battery and nickel-iron battery. nickel-zinc battery is very similar to Lithium ion battery in terms of charge mode, both of which may be charged by means of constant current and constant voltage. Different from nickel-metal hydride battery, nickel-zinc battery may be arbitrarily combined in series and in parallel, to form a module high voltage and large capacity. Coulombic efficiency of charge and discharge thereof is close to that of Lithium ion battery, and may be close to 99% or more, far higher than charge and discharge efficiency of lead-acid battery and nickel-metal hydride battery. Therefore, cyclic performance and specific energy density in terms of weight of nickel-zinc battery is mainly affected by zinc-based negative electrode.

However, the existing nickel-zinc battery has the following technical problems.

The negative electrode of nickel-zinc battery is zinc-based electrode mainly containing active substance such as zinc oxide and zinc powder, where metal zinc is oxidized into zinc oxide or zinc hydroxide during discharge, releasing electrons transferring from the negative electrode side to the positive electrode side, so as to form current. The electrolyte solution of nickel-zinc battery is a strong alkaline aqueous solution containing potassium hydroxide (KOH), sodium hydroxide (NaOH), or lithium hydroxide (LiOH). As a result, such problems may be caused that zinc oxide and zinc hydroxide may be dissolved in the alkaline electrolyte solution, and the zinc-based negative electrode will be dissolved and deform during cycling. The deformation of the negative electrode can easily trigger the growth of zinc dendrite, resulting in short circuit or failure of battery.

Additionally, an alkaline electrolyte solution containing KOH, NaOH and LiOH at 6 mol/L is usually used in nickel-zinc battery. Since hydroxide ion is required to be involved during the electrochemical reaction, a side reaction of gas evolution may be easily occurred at nickel-zinc battery during charge and discharge, when the concentration of hydroxide ion in the electrolyte solution is not less than 6 mol/L, producing hydrogen gas and oxygen gas, and leading to pressure increase within the battery and reduction of charge and discharge coulombic efficiency. When an alkaline electrolyte solution with the concentration of hydroxide ion more than 6 mol/L is used in nickel-zinc battery, metal zinc at the negative electrode side is easily subjected to chemical or electrochemical corrosion in a charge state, leading to problems such as hydrogen evolution and decline of discharge capacity.

Utilization rate of active material ZnO may be calculated by means of practical discharge capacity of nickel-zinc battery. Usually, a practical capacity per gram of ZnO at the negative electrode of nickel-zinc battery is 200 to 230 mAh/g, far below theoretical capacity per gram of ZnO of 658 mAh/g, and the practical utilization rate of the active material ZnO is 30%-35%. Currently, energy density of nickel-zinc battery is 70 to 90 Wh/Kg. In order to further heighten the energy density of nickel-zinc battery, the utilization rate of the active substance ZnO at the negative electrode needs to be further heightened.

Therefore, the existing techniques for nickel-zinc battery mainly have problems such as inferior cyclic performance, lower utilization rate of active material, serious self-discharge, and decline of coulombic efficiency. The performance of these batteries is closely related to growth of zinc dendrite caused by deformation of the negative electrode, chemical corrosion of zinc and gas evolution side reaction of water in the electrolyte solution therein etc.

### SUMMARY

The present invention provides an electrolyte solution for nickel-zinc secondary battery, aiming at solving the existing nickel-zinc battery has problems such as inferior cyclic performance, lower utilization rate of active material, decline of coulombic efficiency during charge and discharge and self-discharge resulted from chemical corrosion of zinc negative electrode.

The following knowledge is obtained by study of zinc electrode of nickel-zinc battery.

The electrolyte solution of nickel-zinc battery is usually an alkaline aqueous solution, mainly containing of electrolytes such as potassium hydroxide, sodium hydroxide and lithium hydroxide. The electrolyte solution mainly plays a role of providing a channel for ion transport, while maintaining electrochemical balance between the positive electrode and the negative electrode. Usually, the negative electrode of nickel-zinc battery mainly consists of zinc oxide and metal zinc powder (85 wt. %-95 wt. %), wherein zinc oxide has a certain solubility in the alkaline aqueous solution, and 1 wt. %-5 wt. % zinc oxide may be completely dissolved in an aqueous solution with 30 wt. %-40 wt. % potassium hydroxide, producing a solution of zincate ion. Particularly, in the case of discharge at high rate, heat production phenomenon of nickel-zinc battery may even aggravate dissolution problem of zinc oxide. Therefore, zinc oxide within zinc negative electrode is dissolved in the alkaline electrolyte solution, easily causing deformation of the negative electrode. The produced zincate ion may freely move in the alkaline electrolyte solution, and easily deposits onto bottom of nickel-zinc battery, due to larger density of zincate ion than that of hydroxide ion. When the zincate ion moves to the negative electrode under the action of electric field during charge, it is easily subjected to electrochemical reduction and deposits to form metal zinc dendrite having puncturing capability, causing short circuit and failure of battery, seriously affecting of nickel-zinc cycle life of battery.

Additionally, zinc electrode also suffers problem of chemical corrosion in the alkaline aqueous solution. Chemical corrosion of zinc may not only reduce utilization rate of the negative electrode active material, causing self-discharge problem, but also cause a side reaction of hydrogen evolution. These problems will greatly reduce discharge capacity and cycle life of battery. Corrosion of zinc electrode occurs in the condition of a pair of conjugated reactions constituted by hydrogen evolution reaction at zinc cathode and oxidization reaction at anode, i.e.:

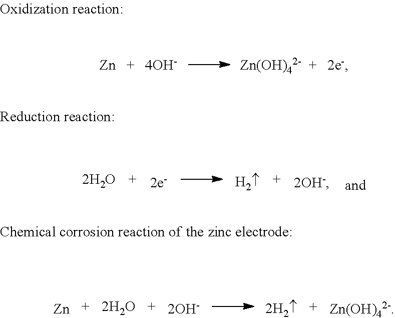

Additionally, since water has higher activity in electrochemical environment, particularly in alkaline electrolyte solution at lower concentration (concentration of hydroxide ion ≤6 mol/L), a side reaction of electrolysis of water is more easily occurred at the negative electrode and the positive electrode, in a range of 1.2 to 1.9 V during charge and discharge cycles. Particularly, water having high activity in the electrolyte solution may be subjected to electrolysis in electrochemical environment, to produce hydrogen gas and oxygen gas, leading to drying up of the electrolyte solution and increase of internal pressure of the battery, and affecting cyclic performance of nickel-zinc battery.

Chemical corrosion of zinc electrode in the alkaline electrolyte solution reduces utilization rate of the active substance ZnO, leading to self-discharge problem of battery, while the produced hydrogen gas increases internal pressure of nickel-zinc battery. Besides, metal zinc in charge state may also be reacted with hydroxide ion in an alkaline environment, i.e. chemical corrosion thereof occurs, to form zincate ion Zn(OH)₄²⁻ and ZnO, and chemical reactions which may occur are shown as below:

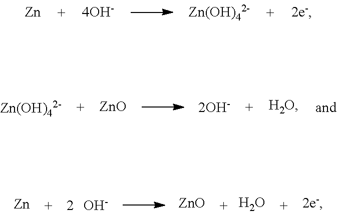

wherein, metal zinc is chemically oxidized into zincate ion and zinc oxide, and the hydroxide ion has a chance to be reduced into hydrogen gas by electrons. When the evolved hydrogen gas is accumulated to a certain amount, nickel-zinc battery may expand interiorly, leading to leakage of the electrolyte solution, producing “alkali creep” problem of battery. These problems greatly reduce discharge capacity, cyclic stability and service life of nickel-zinc battery.

The electrolyte solution provided in the present invention can significantly improve cyclic stability of nickel-zinc battery and utilization rate of active material. Particularly, the solubility of zinc oxide in the alkaline electrolyte solution may be reduced by adding an additive for the electrolyte solution having high solubility, effectively improving short-circuit problem of nickel-zinc battery due to zinc dendrite resulted from deformation of negative electrode. Additionally, this electrolyte solution may not only inhibit chemical corrosion and self-discharge reaction of zinc electrode, heighten utilization rate of active substance and inhibit chemical hydrogen evolution reaction, but also realize the purpose of reducing activity of water, effectively inhibiting electrochemical hydrogen evolution and oxygen evolution reactions of water. Thus, the effect of heightening coulombic efficiency during charge and discharge and reducing the internal pressure of nickel-zinc battery may be achieved.

On the one hand, the present invention provides an electrolyte solution adopting deionized water as a main solvent, which comprises the following components: an electrolyte containing hydroxide radical, a pyrophosphate and a tripolyphosphate.

The electrolyte is at least one selected from a group consisting of potassium hydroxide, sodium hydroxide and lithium hydroxide, and with regard to content of hydroxide radical in the electrolyte solution, the content of hydroxide radical is correspondingly about 7 to 18 mol per 1 L of deionized water.

In one or more embodiments, the electrolyte consists of potassium hydroxide, sodium hydroxide and lithium hydroxide, and a weight ratio of potassium hydroxide, to sodium hydroxide and to lithium hydroxide is 10 to 30:1 to 10:1.

The pyrophosphate is added into the electrolyte solution at such an amount that a ratio of total weight of deionized water and the electrolyte to weight of the pyrophosphate is 1:0.01 to 0.1, i.e. total weight of deionized water and the electrolyte of 100 g corresponds to the added pyrophosphate of 1 to 10 g. Wherein, the pyrophosphate is selected from a group consisting of sodium pyrophosphate and/or potassium pyrophosphate.

The tripolyphosphate is added into the electrolyte solution at such an amount that a ratio of total weight of deionized water and the electrolyte to weight of the tripolyphosphate is 1:0.01 to 0.1, i.e. total weight of deionized water and the electrolyte of 100 g corresponds to the added tripolyphosphate of 1 to 10 g. Wherein, the tripolyphosphate is selected from a group consisting of sodium tripolyphosphate and/or potassium tripolyphosphate.

The pyrophosphate and the tripolyphosphate provided in the present invention have higher solubility in deionized water. For example, potassium pyrophosphate is very soluble in water, solubility of potassium pyrophosphate in 100 g of water is about 187 g under a condition of 25° C., and the aqueous solution of potassium pyrophosphate is alkaline; potassium tripolyphosphate is very soluble in water, solubility of potassium tripolyphosphate in 100 g water is about 140 g under a condition of 25° C., and the aqueous solution of potassium tripolyphosphate is alkaline; and sodium tripolyphosphate is easily soluble in water, solubility of sodium tripolyphosphate in 100 g water is about 20 g under a condition of 25° C., and the aqueous solution of sodium tripolyphosphate is weakly alkaline.

Therefore, additives provided in the present invention, the pyrophosphate and the tripolyphosphate have good compatibility with the alkaline electrolyte solution (KOH, NaOH, and LiOH) of nickel-zinc battery.

On the other hand, the present invention also provides a nickel-zinc battery adopting the above-described electrolyte solution.

The electrolyte solution provided in the present invention has higher content of the electrolyte, i.e. higher content (about 7 to 18 mol/L) of hydroxide radical in the electrolyte solution. Though it is beneficial for reducing activity of water in the electrolyte solution, hydrogen evolution and oxygen evolution reactions in electrochemical environment are inhibited, heightening coulombic efficiency during charge and discharge. However, higher content of hydroxide radical may increase corrosion of zinc electrode of nickel-zinc battery, resulting in problems such as gas evolution and self-discharge of nickel-zinc battery.

Therefore, chemical corrosion of zinc electrode and side reaction of hydrogen evolution can be effectively inhibited, utilization rate of active substance can be heightened, and internal pressure of nickel-zinc battery can be reduced, by controlling amounts of a pyrophosphate and a tripolyphosphate in the electrolyte solution, based on high content of hydroxide ion in the electrolyte solution. Moreover, it is unexpectedly found that, if pyrophosphate or tripolyphosphate is added into the electrolyte solution at excessively high or excessively low amount, inhibition effect of the electrolyte solution from corrosion of zinc electrode may both be reduced. It is speculated that a pyrophosphate and a tripolyphosphate in a certain content range can form a stable and dense solid electrolyte interface protective film with corrosion inhibition effect, having an inorganic substance as a main component, on the surface of the negative electrode of nickel-zinc battery.

This technical solution has the following beneficial technical effects.
1. The electrolyte solution provided in the present invention greatly improves cyclic stability of nickel-zinc battery. In the electrolyte solution, a pyrophosphate and a tripolyphosphate having higher solubility are compatible with the alkaline electrolyte (KOH, NaOH and LiOH), and the activity of water may be effectively inhibited through addition of a pyrophosphate and a tripolyphosphate, reducing occurrence of electrochemical side reaction (for example, gas evolution reaction) to the utmost extent, effectively heightening coulombic efficiency during charge and discharge, and avoiding problems such leakage of the electrolyte solution or “alkali creep” of the battery resulting from increase of internal pressure of nickel-zinc battery.
2. With the electrolyte solution provided in the present invention, deformation problem of the negative electrode of nickel-zinc battery is greatly improved, metal growth of zinc dendrite is effectively avoided during charge, cyclic service life of nickel-zinc battery is heightened, and possibility of short circuit of nickel-zinc battery is greatly reduced, by reducing the solubility of active substance such as zinc oxide in the alkaline electrolyte solution.
3. The electrolyte solution provided in the present invention has high ionic conductivity, and the problem of dissolution of zinc oxide in the electrolyte solution may be effectively inhibited. At the same time, an additive with high solubility contributes to alleviating chemical corrosion problem of metal zinc in charge state under an alkaline condition, and heightens utilization rate of active substance, promoting discharge capacity and specific energy density in terms of weight of nickel-zinc battery.
4. The electrolyte solution provided in the present invention can effectively heighten concentration of hydroxide radical in the electrolyte solution (7 to 18 mol/L), and discharge rate of the battery can be significantly heightened for nickel-zinc battery using this electrolyte solution.

As further improvement of the present invention, the electrolyte solution provided in the present invention may also contain various inorganic or organic additives, and well-known additives may be arbitrarily used. One additive may be used alone, and a combination of two or more arbitrary components and a combination of two or more components in an arbitrary ratio may also be used, as a composite additive. Examples thereof include anti-overcharge agents, additives for widening electrochemical window, and additives for regulating crystal plane growth orientation of zinc and improving capacity retention, capacity recovery, or cycling characteristics after storage at high and low temperatures.

The present invention is described below in combination with specific Examples.

### BRIEF DESCRIPTION OF DRAWINGS

The present invention is further described in conjunction with drawings. However, Examples in drawings does not constitute any limitation on the present invention.

FIG. 1 shows a graph of results of alternating-current impedance test for different electrolyte solutions;

FIG. 2 shows a graph of results of ionic conductivity test for different electrolyte solutions;

FIG. 3 shows a graph of results of electrochemically stable window test for different electrolyte solutions;

FIG. 4 shows a graph of results of cyclic test for button cells corresponding to different electrolyte solutions; and

FIG. 5 shows a charge and discharge curve graph for button cells corresponding to different electrolyte solutions.

### DETAILED DESCRIPTION OF EMBODIMENTS

It should be understood that specific Examples described herein are only used for explaining the present invention, and not for limiting the present invention.

### Electrolyte Solution

The electrolyte solutions provided in Examples 1 to 4 have the ratios of components shown in Table 1.

The electrolyte solutions provided in Comparative Examples 1 to 6 have the ratios of components shown in Table 2.

TABLE 1

| Components of electrolyte solution | Example 1 | | Example 2 | | Example 3 | | Example 4 | |
|---|---|---|---|---|---|---|---|---|
| Electrolyte obtained by compounding | 176.4 | g | 453.6 | g | 250 | g | 350 | g |
| potassium hydroxide, sodium hydroxide and | | | | | | | | |
| lithium hydroxide at a weight ratio of 12:5:1 | | | | | | | | |
| Sodium pyrophosphate | 11.764 | g | / | | 20 | g | 30 | g |
| Potassium pyrophosphate | / | | 145.36 | g | 42.5 | g | 37.5 | g |
| Sodium tripolyphosphate | / | | 14.536 | g | 30 | g | 24 | g |
| Potassium tripolyphosphate | 117.64 | g | / | | 32.5 | g | 30 | g |
| Deionized water | 1 | L | 1 | L | 1 | L | 1 | L |

Wherein, as shown in Table 1, in the electrolyte solution provided in Example 1 of the present invention, electrolytes including potassium hydroxide, sodium hydroxide and lithium hydroxide are compounded at a weight ratio of 12:5: 1. With the electrolyte added in an amount of 176.4 g, regarding to content of hydroxide ion in the electrolyte solution, the content of the corresponding hydroxide ion is about 7 mol per 1 L of deionized water; and in the electrolyte solution, a ratio of total weight of deionized water and the electrolyte to weight of the pyrophosphate is 1:0.01, and a ratio of total weight of deionized water and the electrolyte to weight of the tripolyphosphate is 1:0.1.

In the electrolyte solution provided in Example 2 of the present invention, electrolytes including potassium hydroxide, sodium hydroxide and lithium hydroxide are compounded at a weight ratio of 12:5:1. With the electrolyte added in an amount of 453.6 g, content of hydroxide ion in the electrolyte solution is that content of the corresponding hydroxide ion is about 18 mol per 1 L of deionized water; and in the electrolyte solution, a ratio of total weight of deionized water and the electrolyte to weight of the pyrophosphate is 1:0.1, and a ratio of total weight of deionized water and the electrolyte to weight of the tripolyphosphate is 1:0.01.

TABLE 2

| | | Comparative | Comparative | Comparative | Comparative | Comparative | Comparative |
|---|---|---|---|---|---|---|---|
| Components of | Example | Example | Example | Example | Example | Example | Example |
| electrolyte solution | 4 | 1 | 2 | 3 | 4 | 5 | 6 |
| Electrolyte obtained by | 350 g | 350 g | 350 g | 350 g | 350 g | 350 g | 350 g |
| compounding | | | | | | | |
| potassium hydroxide, | | | | | | | |
| sodium hydroxide and | | | | | | | |
| lithium hydroxide at a | | | | | | | |
| weight ratio of 12:5:1 | | | | | | | |
| Sodium pyrophosphate | 30 g | / | 30 g | 30 g | / | / | / |
| Potassium | 37.5 g | / | 37.5 g | 37.5 g | / | / | / |
| pyrophosphate | | | | | | | |
| Sodium | 24 g | 24 g | / | / | 24 g | / | / |
| tripolyphosphate | | | | | | | |
| Potassium | 30 g | 30 g | / | / | 30 g | / | / |
| tripolyphosphate | | | | | | | |
| Sodium | / | / | / | 24 g | / | 30 g | / |
| hexametaphosphate | | | | | | | |
| potassium | / | / | / | 30 g | / | 37.5 g | / |
| metaphosphate | | | | | | | |
| Sodium | / | / | / | / | 30 g | 24 g | / |
| hexafluorophosphate | | | | | | | |
| Potassium | / | / | / | / | 37.5 g | 30 g | / |
| hexafluorophosphate | | | | | | | |
| Deionized water | 1 L | 1 L | 1 L | 1 L | 1 L | 1 L | 1 L |

A preparation method for the electrolyte solution provided in Example 4 of the present invention includes the following steps:
step (1), weighing potassium hydroxide, sodium hydroxide, lithium hydroxide, sodium pyrophosphate, potassium pyrophosphate and sodium tripolyphosphate, potassium tripolyphosphate and deionized water for later use;
step (2), adding 900 mL of deionized water into a plastic container, adding an electrolyte obtained by compounding potassium hydroxide, sodium hydroxide and lithium hydroxide at a weight ratio of 12:5:1 into the container for multiple times, and stirring a resulted mixture to achieve complete dissolution;
step (3), adding potassium pyrophosphate and sodium pyrophosphate into the above-described solution after the above-described solution is clear, and continuing to constantly stir a resulting mixture to obtain a clear solution; and
step (4), adding potassium tripolyphosphate and sodium tripolyphosphate into the above-described solution after the above-described solution is completely clear, constantly stirring to obtain a clear solution, adding the remaining deionized water, and cooling the solution to a fixed volume.

In the above-described step (1) to step (4), speed of the stirring is 300 to 400 rpm, the stirring is performed at room-temperature condition, and electrical resistivity of deionized water is about 18.2 MΩ·cm. In the step (2), the electrolyte is added in batches for multiple times, the previously added electrolyte needs to be completely dissolved when the next batch of electrolyte is added, and adding the electrolyte is preferably performed for 3 to 5 times. In the step (3), it may be taken into account to heat the solution to 60 to 80° C., promoting dissolution of potassium pyrophosphate and sodium pyrophosphate. In the step (4), since the electrolyte containing hydroxide radical releases heat when being dissolved in water, the electrolyte solution of the present invention is cooled at room temperature for 2 to 5 hours, filtered and injected into a case of nickel-zinc battery.

### Nickel-Zinc Battery

Nickel-zinc battery of the present invention has a positive electrode, a negative electrode, a separator and the electrolyte solution of the present invention.

### 1. Structure of Battery

Except for the electrolyte solution, the structure of nickel-zinc battery of the present invention is same as that of a well-known nickel-zinc battery, and usually has such a form that a porous, liquid-absorbing, and microporous composite membrane (separator) impregnated with the electrolyte solution of the present invention sandwiched between a nickel hydroxide positive electrode and a zinc oxide negative electrode is laminated or wound, and put in a plastic or metal container (housing). Therefore, there are no special restrictions on the shape of nickel-zinc battery of the present invention. For example, the shape may include cylindrical type, square type, laminated type, coin type, large type or the like type.

### 2. Electrolyte Solution

The above-described electrolyte solution of the present invention is adopted. In addition, the electrolyte solution of the present invention may also be used in combination with other electrolyte solutions, within the scope without going beyond the gist of the present invention.

### 3. Fabrication Method for Negative Electrode

The negative electrode may be fabricated by adopting any a well-known method, as long as effects of the present invention are not obviously impaired. For example, negative electrode active substance (with the negative electrode active substance being one or a mixture of more of zinc oxide, calcium zincate, zinc powder, carbon-coated zinc oxide, carbon-coated calcium zincate, metal-coated zinc powder and polydopamine loading zinc oxide) may be added with an organic binder (sodium carboxymethylcellulose, styrene-butadiene rubber, polytetrafluoroethylene, polyvinyl alcohol, sodium polyacrylate) and a solvent (deionized water). According to the practical requirement, thickener, electrically conductive material, filling material, hydrophilic agent, organic dispersant, surfactant or the like may also be added, so as to prepare slurry. The slurry is uniformly coated on metal current collector, and the resulting metal current collector is dried and subjected to steps of roll pressing, cutting, kneading, welding and the like, to form a zinc oxide negative electrode. In addition, the negative electrode active substance may be subjected to roll pressing and molding to prepare a sheet electrode, or be subjected to pressing and molding to prepare pellet electrode. As the current collector maintaining the negative electrode active substance, well-known current collectors may be arbitrarily used. As the current collector of the negative electrode, for example, metallic materials such as copper foil, copper cable-stayed mesh, stainless steel strip, tinned copper foil, tinned copper mesh, tinned foamy copper, silvered copper mesh, punched titanium foil, punched tinned copper strip, and tinned copper strip with three dimensional structure may be exemplified.

When the negative electrode active substance is prepared in the negative electrode, there are no special restrictions on the electrode structure, and density of the negative electrode active substance on the current collector is in a range of 3 to 6 g/cm³, preferably 3.5 to 4.5 g/cm³.

### 4. Fabrication Method for Positive Electrode

The positive electrode may be fabricated by forming a positive electrode active substance layer containing positive electrode active substance (nickel hydroxide or cobalt-coated nickel hydroxide) and an organic binder (polytetrafluoroethylene emulsion, butadiene styrene rubber emulsion or sodium carboxymethylcellulose) on a current collector, in accordance with a well-known method. For example, the following method may be used: uniformly mixing positive electrode active substance and an organic binder, as well as electrically conductive material and thickener etc. as required, so as to prepare a sheet, and pressing and adhering the resulting sheet on a positive electrode current collector to prepare the positive electrode. Alternatively, for example, the following method may also be used: dissolving or dispersing the materials in a liquid medium to prepare slurry, coating the slurry on a positive electrode current collector and drying the coated current collector, and subjecting the coated current collector after being dried to steps of roll pressing, cutting, kneading, welding and the like, so as to form a positive electrode active substance layer on the current collector through, thereby preparing the positive electrode.

As the electrically conductive material, a well-known electrically conductive material may be arbitrarily used. For example, the following materials may be exemplified: metallic materials such as copper, tin, indium, silver, bismuth, tungsten, titanium, manganese, zinc and nickel; graphite such as natural graphite and artificial graphite; carbon black such as acetylene black and ketjen black; and amorphous carbonaceous material such as needle coke. It should be noted that one of these substances may be used alone, and two or more of these substances may also be used in an arbitrary combination and ratio.

There are no special restrictions on the material as the positive electrode current collector, and a well-known material may be arbitrarily used. For example, the following materials may be exemplified: metallic materials such as foamy nickel, nickel foil, aluminium foil, stainless steel strip, nickel-plated stainless steel, punched nickel strip, nickel strip with three dimensional structure and titanium; and carbonaceous material such as carbon cloth, carbon paper, grapheme paper and graphite paper.

### 5. Separator

The separator is usually interposed between positive electrode and negative electrode of battery, used for transport of electrolyte ion within the battery, and preventing short circuit of the battery at the same time. At this time, the separator may be immersed in the electrolyte solution of the present invention and utilized. There are no special restrictions on material and shape for the separator, as long as effects of the present invention are not obviously impaired, and a well-known separator may be arbitrarily adopted. Wherein, it is preferable to use such separator that is an article in a form of porous sheet and non-woven fabric etc. having excellent liquid retention characteristics, which is formed of a stable material for the electrolyte solution of the present invention, or by utilizing resin, glass fiber, plant fiber, chemical fiber and inorganic substance etc. As a material for the separators utilizing resin and glass fiber, for example, polyolefin such as polyethylene and polypropylene, and polytetrafluoroethylene, polyether sulfone and glass fabric filter etc. may be used. Wherein, glass fabric filter and polyolefin are preferable, and polyolefin is more preferable. One of these materials may be used alone, and two or more of these materials may also be used in an arbitrary combination and ratio.

### 6. Electrode Assembly

There are no special restrictions on the electrode assembly, and the following electrode assembly may be exemplified: an electrode assembly with laminated structure formed by sandwiching the above-described separator between the above-described positive electrode plate and negative electrode plate, and an electrode assembly formed by sandwiching the above-described separator between the above-described positive electrode plate and negative electrode plate, and winding the resulting laminate into a spiral structure.

### 7. Housing

A nickel-zinc battery of the present invention is usually constituted by encapsulating the above-described electrolyte solution, negative electrode, positive electrode and separator in a housing. There are no special restrictions on the housing, and a well-known housing may be arbitrarily used. For example, the following housings may be exemplified: metals such as nickel-plated steel plate, stainless steel plate, tinned stainless steel, tinned iron plate, tinplate plate, copper coated aluminium, aluminium or aluminium alloy and magnesium alloy, plastics such as acrylonitrile-butadiene-styrene copolymer (ABS) plastic, polypropylene (PP) plastic, polyetheretherketone (PEEK) plastic, polyvinyl chloride (PVC) or the like, and laminated film of resin and aluminium foil. From the viewpoint of lightweighting, it is preferable to use ABS plastic. For a housing using the above-described metals, the following housings may be exemplified: a housing having closed structure formed through welding metals to each other by means of laser welding, resistance welding and ultrasonic welding, and a housing having riveted structure formed through using the above-described metals by means of resin-made gasket. In addition, there are no special restrictions on shape of the housing, for example, cylindrical type, square type, laminated type, coin type, large type or the like type may be exemplified.

### Comparative Test

Nickel-zinc batteries are respectively fabricated by using the electrolyte solutions provided in Examples 1 to 4 and the electrolyte solutions provided in Comparative Examples 1 to 6, and fabrication methods for nickel-zinc batteries all include the following steps:
step (1), preparation of positive electrode: uniformly mixing nickel hydroxide, metal nickel powder, sodium carboxymethylcellulose and polytetrafluoroethylene in accordance with a weight ratio of about 90:4: 3:3, fully grinding the resulting mixture into a slurry, uniformly coating the resulting slurry on both sides of foamy nickel with thickness of 2 mm (areal density: 250 g/cm²), and drying the resulting foamy nickel, and then pressing it, so that a positive electrode active substance layer has a density of 3 to 4 g/cm³, followed by steps of roll pressing, cutting, kneading, welding and the like, to prepare a Ni(OH)₂ positive electrode;
step (2), preparation of negative electrode: mixing carbon-coated zinc oxide, metal zinc powder, bismuth oxide, hydroxyethyl cellulose, butadiene styrene rubber, and polytetrafluoroethylene in accordance with a weight ratio of 75:15:5:1.5:1.5:2, and uniformly mixing the resulting mixture with deionized water under the action of a vacuum planetary mixer, to prepare negative electrode active substance slurry; uniformly coating the prepared active substance slurry on tinned copper foil with thickness of about 20 μm, and drying the tinned copper foil, and then pressing it, so that the negative electrode active substance layer has a density of 1.5 to 4.5 g/cm³, followed by steps of roll pressing, cutting, kneading, welding and the like, to prepare a ZnO negative electrode having the active material ZnO as a main component;
step (3), preparing a composite film composed of a polypropylene non-woven fabric film capable of absorbing liquid with thickness of about 100 μm and a hydrophilic microporous film with thickness of 20 μm, as a separator; and
step (4), laminating the above-described positive electrode, negative electrode, and separator in accordance with a sequence of negative electrode, separator, positive electrode, separator, negative electrode; packaging the resulting element of nickel-zinc battery as above with a cannular aluminium laminated film, with various electrolyte solutions according to Examples and Comparative Examples injected therein, and then performing vacuum sealing, so as to prepare a sheet-shaped nickel-zinc battery. Moreover, in order to heighten tightness between the electrodes, the sheet-shaped battery is clamped via glass plates and pressed.

The fabricated nickel-zinc battery is subjected to a test for capacity retention rate after cycles:

### Initial Charge and Discharge

In a thermostatic bath at 25° C., the sheet-shaped nickel-zinc battery is subjected to charge to 1.9 V with constant current and constant voltage at 0.1 C, and then discharge to 1.2 V at 0.1 C. The battery is stable after the above-described charge and discharge for 5 cycles. A discharge capacity at 5th cycle is regarded as an initial capacity. It should be noted that 1 C refers to current value at which total capacity of the battery is discharged within one hour.

Cyclic test at normal temperature

The battery subjected to initial charge and discharge is subjected to the following charge and discharge for 300 cycles at 25° C.: performing constant current charge to 1.9 V at 0.5 C, and performing charge to cutoff current of 0.05 C by means of constant voltage at 1.9 V; and then performing constant current discharge to 1.2 V at 0.5 C. A ratio of discharge capacity at 300th cycle to initial capacity is regarded as a capacity retention rate after cycles.

### Cyclic Test at High Temperature

The battery subjected to initial charge and discharge is subjected to the following charge and discharge for 300 cycles at 60° C.: performing constant current charge to 1.9 V at 0.5 C, and performing charge to cutoff current of 0.05 C by means of constant voltage at 1.9 V; and then performing constant current discharge to 1.2 V at 1 C. A ratio of discharge capacity at 300th cycle to initial capacity is regarded as a capacity retention rate after cycles.

### Cyclic Test at Low Temperature

The battery subjected to initial charge and discharge is subjected to the following charge and discharge for 100 cycles: at 25° C., performing charge to 1.9 V by means of constant current charge at 0.2 C, and performing charge to cutoff current of 0.05 C by means of constant voltage at 1.9 V; and then, placing the battery in a environment temperature of −25° C. for 6 hours, and performing constant current discharge at 0.2 C at −25° C., and placing the battery in a environment temperature of 25° C. for 6 hours. A ratio of discharge capacity at 100th cycle to initial capacity is regarded as a capacity retention rate after cycles.

The test result of capacity retention rate after cycles is shown in Table 3.

TABLE 3

| Test for capacity | Capacity retention rate (%) | | |
|---|---|---|---|
| retention rate after | Cycles at | Cycles at | Cycle at |
| cycles of nickel- | normal | high | low |
| zinc battery | temperature | temperature | temperature |
| Example 1 | 65 | 70 | 62 |
| Example 2 | 69 | 74 | 61 |
| Example 3 | 66 | 72 | 60 |
| Example 4 | 70 | 74 | 66 |
| Comparative Example 1 | 52 | 58 | 41 |
| Comparative Example 2 | 53 | 62 | 44 |
| Comparative Example 3 | 54 | 61 | 50 |
| Comparative Example 4 | 51 | 63 | 48 |
| Comparative Example 5 | 49 | 58 | 44 |
| Comparative Example 6 | 40 | 48 | 39 |

The following conclusion can be drawn from the results in Table 3.

Firstly, in comparison of Examples 1 to 4 involving the electrolyte solutions provided in the present invention, with Comparative Example 6 involving the electrolyte solution not containing a pyrophosphate and a tripolyphosphate, the capacity retention rate after cycles of nickel-zinc battery comprising the electrolyte solution provided in the present invention is obviously heightened at normal temperature, at high temperature and at low temperature.

Secondly, in comparison of Example 4 with Comparative Example 5, the capacity retention rate after cycles of nickel-zinc battery comprising the electrolyte solution provided in the present invention is obviously heightened at normal temperature, at high temperature and at low temperature, indicating that the electrolyte solution provided in the present invention added with a pyrophosphate and a tripolyphosphate greatly improves cyclic stability of nickel-zinc battery. It should be pointed out that sodium hexafluorophosphate and potassium hexafluorophosphate has better solubility in water, in Comparative Example 5. Since hexafluorophosphate radical belongs to a non-coordinating anion, sodium hexafluorophosphate and potassium hexafluorophosphate has stronger acidity in aqueous solution, which may significantly reduce the concentration of hydroxide ion in the electrolyte solution, and therefore, the additives provided in Comparative Example 5 have inferior compatibility with the alkaline electrolyte solution.

Thirdly, in comparison of Example 4 with Comparative Examples 1 to 4, the capacity retention rate after cycles of nickel-zinc battery comprising the electrolyte solution provided in the present invention is obviously heightened at normal temperature, at high temperature and at low temperature, indicating that absence or substitution of any one component from the combination of pyrophosphate with tripolyphosphate may adversely affect charge and discharge cyclic performance of nickel-zinc battery within wider temperature range.

It may be known from the above result that nickel-zinc battery using the electrolyte solution of the present invention has excellent discharge characteristics and cyclic characteristics at high temperature and at low temperature.

### Effect of Amounts of the Added Pyrophosphate and Tripolyphosphate on Electroconductivity of Electrolyte Solution

In order to further study effect of a pyrophosphate and a tripolyphosphate at different contents on the electroconductivity of electrolyte solution, a basic electrolyte solution 1#is firstly prepared, wherein potassium hydroxide, sodium hydroxide and lithium hydroxide are compounded at a weight ratio of 22:2: 1into an electrolyte, corresponding of electrolyte is added into the electrolyte solution at an amount of about 252 g per 1 L of deionized water. 1252 g of the basic electrolyte solution 1#is weighed for multiple times and respectively poured in plastic containers, and different amounts of potassium pyrophosphate and sodium tripolyphosphate are respectively added, to prepare electrolyte solutions 2#, 3#, 4#, 5#, 6#, and 7#containing different components, whose specific components are shown in Table 4.

TABLE 4
Components of electrolyte solution

| | |
|---|---|
| 1# | basic electrolyte solution: 1 L of deionized water + 252 g of |
| | electrolyte (electrolyte obtained by compounding potassium |
| | hydroxide, sodium hydroxide and lithium hydroxide at a weight |
| | ratio of 22:2:1) |
| 2# | 1252 g of basic electrolyte solution + 12.52 g of sodium |
| | pyrophosphate + 125.2 g of potassium tripolyphosphate |
| 3# | 1252 g of basic electrolyte solution + 12.52 g of sodium |
| | pyrophosphate |
| 4# | 1252 g of basic electrolyte solution + 125.2 g of potassium |
| | tripolyphosphate |
| 5# | 1252 g of basic electrolyte solution + 12.52 g of potassium |
| | pyrophosphate |
| 6# | 1252 g of basic electrolyte solution + 12.52 g of sodium |
| | tripolyphosphate + 125.2 g of potassium pyrophosphate |
| 7# | 1252 g of basic electrolyte solution + 12.52 g of sodium |
| | tripolyphosphate |

The electrolyte solutions containing different contents of additives shown in Table 4 are subjected to ionic conductivity test, and specific experimental steps thereof are as follows:
step (1), preparing an electrolyte solution to be measured, and subjecting an electroconductivity meter to calibration by using the existing 1 M KCl standard solution, to guarantee measurement accuracy;
step (2), completely immersing electrodes of the electroconductivity meter in the electrolyte solution to be measured, starting an electrochemical working station CHI 660E, performing alternating-current impedance test (EIS), and recording solution temperature during the measurement;
step (3), recording all the relating data including electroconductivity value, temperature, experimental conditions or the like; and
step (4), analyzing data, and determining ionic conductivity of the electrolyte solution.

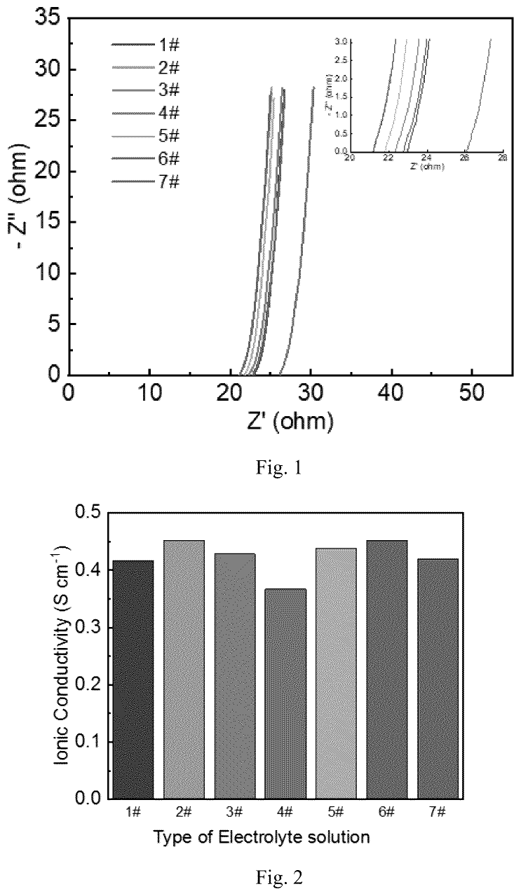

Results of measuring and analyzing are shown in FIG. 1 and FIG. 2. FIG. 1 shows a graph of results of alternating-current impedance test for different electrolyte solutions. It is generally believed that the resistance is mainly affected by ion diffusion at low frequency, and therefore, the intersection point value of the resulting figure line with x-axis is regarded as the impedance during ion diffusion. The test result of ionic conductivity for different electrolyte solutions shown in FIG. 2 may be obtained by substituting the impedance into the ionic conductivity calculation formula. It is demonstrated from the study result that the ionic conductivity of electrolyte solution may be effectively heightened by adding appropriate amount of potassium pyrophosphate and sodium tripolyphosphate. However, if the added concentration thereof is excessively high, it may lead to reduction of ionic conductivity. Additionally, adding a pyrophosphate and a tripolyphosphate at the same time may significantly improve the ionic conductivity of electrolyte solution, in comparison with adding pyrophosphate or tripolyphosphate alone.

### Effect of a Pyrophosphate and a Tripolyphosphate on Electrochemically Stable Window of Electrolyte Solution

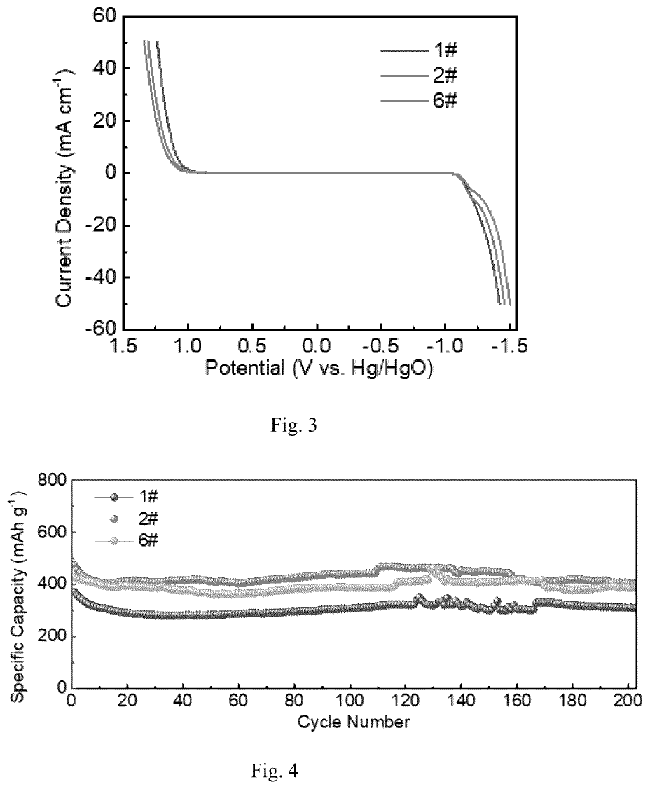

The basic electrolyte solution 1#, the electrolyte solution 2#and the electrolyte solution 6#are respectively subjected to a test on electrochemically stable window, and specific experimental steps thereof are as follows: firstly, subjecting the different electrolyte solutions to cyclic voltammetry test by means of a electrochemical working station CHI 660E, under a three-electrode system (working electrode, counter electrode Pt, reference electrode Hg/HgO). Scanning is performed from negative potential to positive potential, followed by reverse scanning, covering an expected stable window. The cyclic voltammetry (CV) curve is analyzed to determine positive and negative potential limits at which the electrolyte does not decompose, and a range between the the positive and negative potential limits is the electrochemically stable window. The experimental conditions include a scanning rate of 1 m V/s, and a scanning range from 1.5 V to −1.5 V. The test result is shown in FIG. 3, wherein the electrochemically stable window of the electrolyte solution added with additives is measured to be 2.019 V, obviously superior to that of the basic electrolyte solution without any additive (1.842 V). Since the electrochemically stable window is an important parameter for evaluating stable range of electrolyte in a given electrode material, it may be believed that the wider the electrochemically stable window is, the better stability the electrolyte solution has during electrochemical reaction process, and the more obvious the effect for inhibiting activity of water is. Thereby, stability of nickel-zinc battery during cycle may be effectively heightened, and performance of nickel-zinc battery is improved.

### Effect of a Pyrophosphate and a Tripolyphosphate on Cyclic Performance of Electrolyte Solution

The basic electrolyte solution 1#, the electrolyte solution 2#and the electrolyte solution 6#are respectively adopted to assemble a button cell CR2032 for cyclic test. Specific details of the assembling are as follows: Ni(OH)₂ active material is used as a positive electrode, carbon-coated zinc oxide active material is used as a negative electrode, and CR2032 button cell housing is used together with the supporting gasket and shrapnel. The test result is shown in FIG. 4. After the pyrophosphate and the tripolyphosphate are added into the electrolyte solution, it can be seen that the capacity per gram during cycle of button cell is significantly heightened in a normal-temperature environment. The button cell adopting basic electrolyte solution 1#has an initial capacity per gram of only 371 mAh/g, and corresponding ZnO utilization rate thereof is 56%. The button cell adopting electrolyte solution 2#has an initial capacity per gram up to 475 mAh/g, and corresponding ZnO utilization rate thereof is 72%. The button cell adopting electrolyte solution 6#has an initial capacity per gram up to 430 mAh/g, and corresponding ZnO utilization rate thereof is 65%. It is worth mentioning that the button cell adopting electrolyte solution 2#still has a ZnO capacity per gram of 407 mAh/g after 200 cycles, and capacity retention rate thereof is 86%; and the button cell adopting electrolyte solution 6#has a ZnO capacity per gram of 388 mAh/g, and capacity retention rate thereof is up to 90%. However, the button cell adopting the basic electrolyte solution 1#only has a ZnO capacity per gram of 310 mAh/g, and capacity retention rate thereof is only 84%. Thus, it can be seen that it contributes to improvement of the capacity per gram and the capacity retention rate after cycles of ZnO negative material of nickel-zinc battery to add a pyrophosphate and a tripolyphosphate into the basic electrolyte solution.

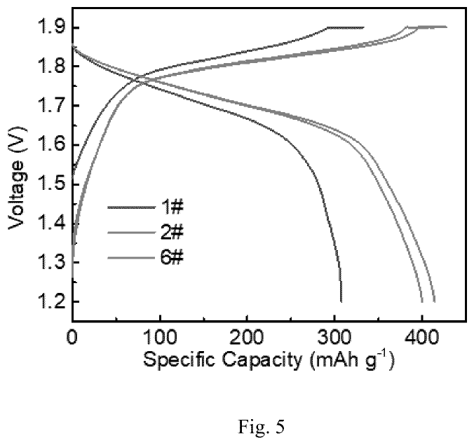

FIG. 5 shows a charge and discharge curve graph of CR2032 button cells corresponding to different electrolyte solutions. By comparing charge and discharge curves at the 5th cycle of the three button cells, it may be obviously seen that the potential difference between charge plateau and discharge plateau of the battery added with a pyrophosphate and a tripolyphosphate becomes smaller, indicating that the added pyrophosphate and tripolyphosphate may well improve polarization phenomenon of the battery, and heighten reversibility of electrochemical reaction, which further explains why the capacity retention rate is promoted.

The technical features of Examples described above may be arbitrarily combined, and for the sake of conciseness, all possible combinations of the technical features in the above Examples are not described. However, as long as there is no contradiction between the combinations of these technical features, they shall be deemed to be within the scope of this description.

The above Examples only express several embodiments of the present invention, and their descriptions are more specific and detailed, but they cannot be understood as limiting the scope of protection of the invention. It should be noted that for a person skilled in the art, a number of variants and improvements can be made without departing from the conception of the present invention, which are within the scope of protection of the present invention. Therefore, the scope of protection of the invention shall be determined by the appended claims.

1. An electrolyte solution adopting deionized water as a main solvent, characterized in that,
the electrolyte solution comprises the following components: an electrolyte containing hydroxide radical, a pyrophosphate and a tripolyphosphate;
with regard to content of hydroxide radical in the electrolyte solution, the content of hydroxide radical corresponding to per 1 L of deionized water is 7 to 18 mol;
a ratio of total weight of deionized water and the electrolyte to weight of the pyrophosphate is 1:0.01 to 0.1; and
a ratio of total weight of deionized water and the electrolyte to weight of the tripolyphosphate is 1:0.01 to 0.1.

2. The electrolyte solution according to claim 1, characterized in that, the electrolyte is at least one selected from a group consisting of potassium hydroxide, sodium hydroxide and lithium hydroxide.

3. The electrolyte solution according to claim 2, characterized in that, the electrolyte consists of potassium hydroxide, sodium hydroxide and lithium hydroxide, and a weight ratio of the potassium hydroxide, to the sodium hydroxide and to the lithium hydroxide is 10 to 30:1 to 10:1.

4. The electrolyte solution according to claim 1, characterized in that, the pyrophosphate is selected from a group consisting of sodium pyrophosphate and/or potassium pyrophosphate.

5. The electrolyte solution according to claim 1, characterized in that, the tripolyphosphate is selected from a group consisting of sodium tripolyphosphate and/or potassium tripolyphosphate.

6. A nickel-zinc battery, comprising the electrolyte solution according to claim 1.
